(19) United States
(12) Patent Application Publication
(10) Pub. No.: US 2007/0203956 A1
(43) Pub. Date: Aug. 30, 2007

(54) Metadata Customization Using Diffgrams

(75) Inventors: Jeffrey R. Anderson, West Fargo, ND (US); Tristan H. Cartony, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/364,743

(22) Filed: Feb. 28, 2006

(51) Int. Cl. G06F 17/30

(52) U.S. Cl. 707/203

(57) ABSTRACT

A computer-implemented method of obtaining a metadata instance defining at least part of a customized application includes loading a baseline metadata instance for the application. At least one diffgram corresponding to a customization of the baseline metadata instance for the application is obtained. Then at least one diffgram is applied to generate the metadata instance defining at least part of the customized application from the baseline metadata instance and at least one diffgram.

### BACKGROUND

Frequently, application developers develop applications which will be customized by one or more individuals or groups. For example, an application may be customized by one or more independent software vendors (ISVs), by system administrators of a computer system on which the application will run, and/or by end users. Keeping track of the customizations, while maintaining the ability to update the application and still have the product run properly using the previously applied customizations can be challenging.

Metadata is information about other data. Metadata is becoming more and more heavily used in applications as developers strive to provide a more customizable product. Metadata can be desirable since it is frequently easier to update than compiled code. However, the use of metadata does not solve the problem of how to let multiple updates be made to an application or product by different groups, while still allowing the product to run properly even if one or more of these updates are not included. The problem is further exacerbated when the underlying product is upgraded. Sometimes, the customizations to the application may not continue working after an upgrade of the application or product.

The discussion above is merely provided for general background information and is not intended to be used as an aid in determining the scope of the claimed subject matter.

### SUMMARY

With application products often being customizable, challenges can be presented in the form of how to let multiple different updates or customizations be made to the product by different groups, while still allowing the product to run properly even if one or more of these updates are not included. Further challenges can be presented when the underlying product is itself upgraded, which could result in the previous customizations or updates no longer working.

Methods of metadata customization using diffgrams are presented. Using these methods, the only part of an update or customization to metadata that is actually saved is the part that is different from the original. The metadata diffgrams, which define the differences between the update or customization of the metadata relative to the original metadata, can be generated for customizations of the original application product by independent software vendors (ISVs), system administrators, end users, or others. Then at runtime, the diffgrams are applied to the underlying metadata to build up a new metadata definition that represents the updated metadata. This methodology is described below in greater detail.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a one computing environment in which some embodiments may be practiced.

FIG. 2-1 is a flow diagram illustrating a method embodiment.

FIG. 2-2 is a block diagram illustrating aspects of disclosed embodiments.

FIG. 2-3 is a block diagram illustrating aspects of disclosed embodiments.

FIG. 3 is a flow diagram illustrating method embodiments.

FIG. 4 is a flow diagram illustrating method embodiments.

FIG. 5 is a flow diagram illustrating method embodiments.

FIG. 6 is a flow diagram illustrating method embodiments.

FIGS. 7-1 through 7-6 are illustrations of an example of some embodiments.

### DETAILED DESCRIPTION

As noted, metadata is becoming more and more heavily used in applications as developers strive to provide a more customizable product. Metadata can be desirable since it is often easier to update than typical compiled code. However, the use of metadata does not solve the problem of how to let multiple updates be made to a product by different groups, while still allowing the product to run properly even if one or more of these updates are not included. The use of metadata also does not solve the problems associated with aiding or ensuring that the updates and customizations will continue working when the underlying product is upgraded.

Disclosed embodiments utilize a methodology of metadata customization through diffgrams. Using this methodology, the only part of an update or customization to metadata that is actually saved is the part that is different from the original. The metadata diffgrams, which define the differences between the update or customization of the metadata relative to the original metadata or relative to a previous update or customization, can be generated for customizations of the application product by independent software vendors (ISVs), system administrators, end users, or others. Then at runtime, the diffgrams are applied to the underlying metadata to build up a new metadata definition that represents the updated metadata. This methodology is described below in greater detail.

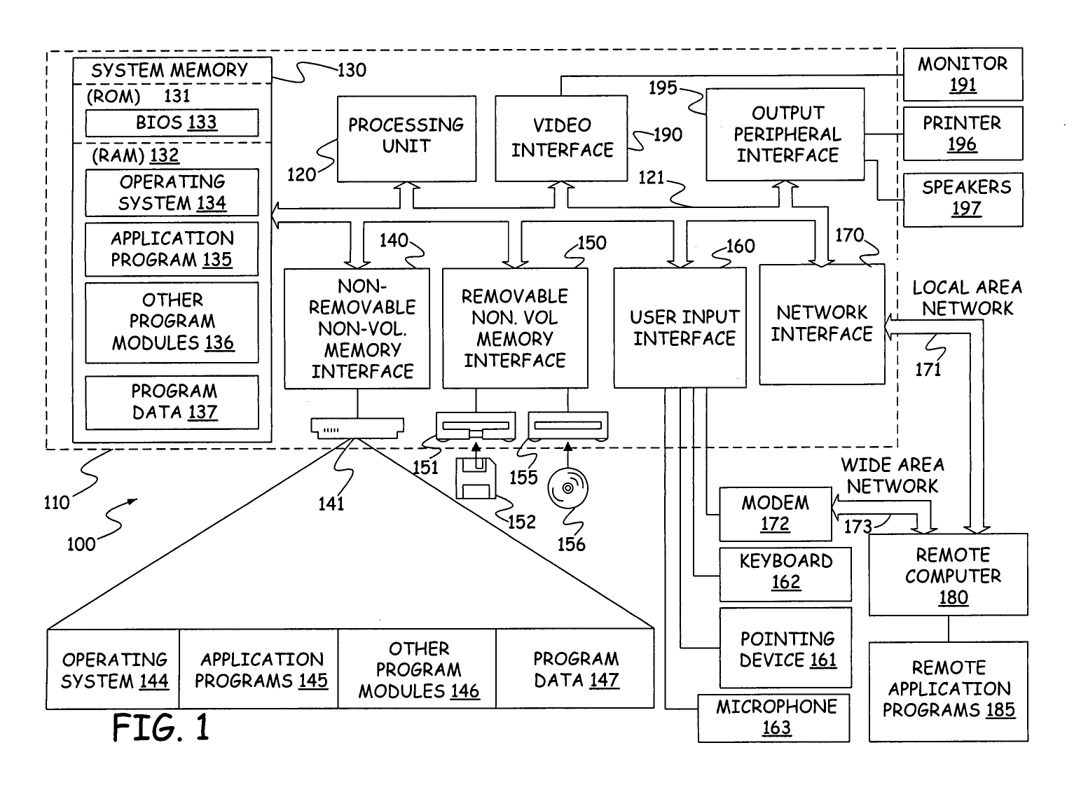

The disclosed metadata instance defining methods, apparatus and systems can be embodied in a variety of computing environments, including personal computers, hand held computers, laptop computers, notebook computers, server computers, etc. Before describing the embodiments in greater detail, a discussion of an example computing environment in which the embodiments can be implemented may be useful. FIG. 1 illustrates one such computing environment which can represent any of these different types of computing environments. As such, FIG. 1 should be understood to represent a computing environment configured to implement one or more aspects of the disclosed methods, systems or apparatus.

FIG. 1 illustrates an example of a suitable computing system environment 100 on which one or more aspects of the illustrated embodiments may be implemented. The computing system environment 100 is only one example of a suitable computing environment and is not intended to suggest any limitation as to the scope of use or functionality of the illustrated embodiments. Neither should the computing environment 100 be interpreted as having any dependency or requirement relating to any one or combination of components illustrated in the exemplary operating environment 100.

The illustrated embodiments are operational with numerous other general purpose or special purpose computing system environments or configurations. Examples of well-known computing systems, environments, and/or configurations that may be suitable for use with the illustrated embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The illustrated embodiments may be described in the general context of computer-executable instructions, such as program modules, being executed by a computer. Generally, program modules include routines, programs, objects, components, data structures, etc. that perform particular tasks or implement particular abstract data types. The illustrated embodiments may also be practiced in distributed computing environments where tasks are performed by remote processing devices that are linked through a communication network. In a distributed computing environment, program modules may be located in both local and remote computer storage media including memory storage devices. Tasks performed by the programs and modules are described below and with the aid of figures. Those skilled in the art can implement the description and figures provided herein as processor executable instructions, which can be written on any form of a computer readable medium.

With reference to FIG. 1, an exemplary system includes a general-purpose computing device in the form of a computer 110. Components of computer 110 may include, but are not limited to, a processing unit 120, a system memory 130, and a system bus 121 that couples various system components including the system memory to the processing unit. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

Metadata is literally just information about another set of data, so it may take many forms. Some typical embodiments of metadata include XML (extensible markup language), information in a database, attribute-based information, and many others. This discussion will use XML as an example just for ease of discussion, but those of skill in the art will recognize that the concepts of disclosed embodiments can be applied to other metadata types.

Consider as an example an XML definition of a page displayed within an application. A company or application developer typically ships a standard “base” definition of that page. An ISV may wish to add a couple fields to that page, change some colors, change the layout, etc. Then the administrator at an installation site may wish to add a couple more installation specific fields, remove some other fields (potentially even those added by the ISV), etc. Also, an end user may wish to further customize the page by changing layouts, colors, etc.

Rather than storing each of these customizations as a separate version of the product, in accordance with disclosed embodiments the metadata customizations are instead saved as diffgrams based upon the previous level of customizations. Diffgram is a term sometimes used to describe an XML format which identifies current and original versions of data elements. For example, if a data set uses an XML format to store and transfer data, it can also typically use diffgrams to keep track of the original data and the current data by storing differences between the two. One example of diffgram usage is the Microsoft® XML Diff Language (XDL). Generally, as used in this document, diffgrams describe the differences between two metadata documents. In the case of XDL, diffgrams describe the differences between two XML metadata documents. However, as used herein, diffgrams can be used to describe the differences between two metadata documents in any particular format, and are not limited to XML metadata documents.

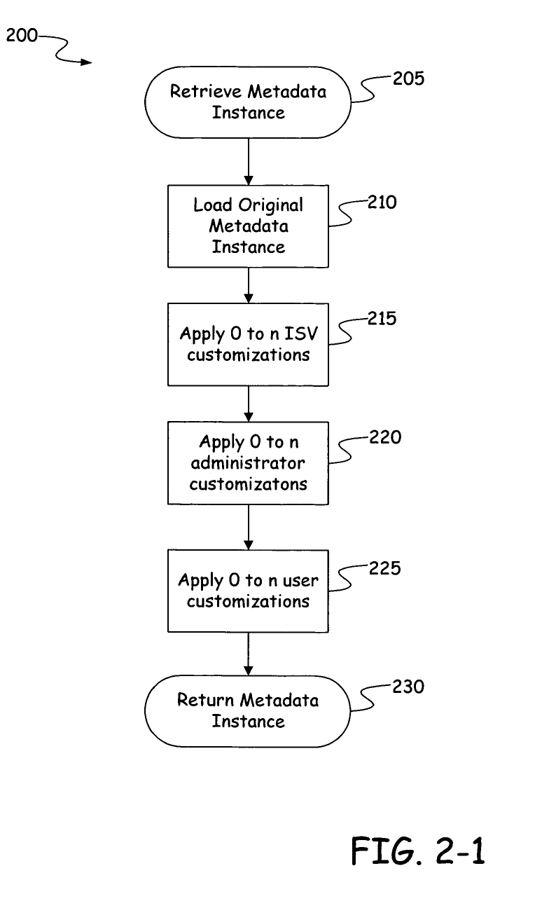

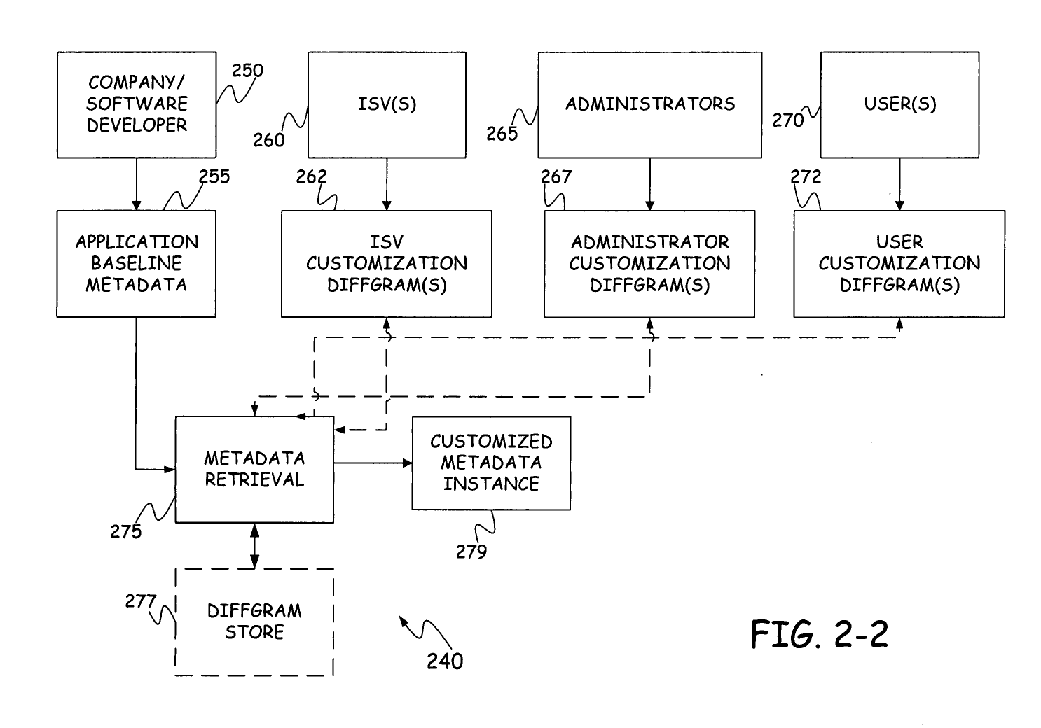

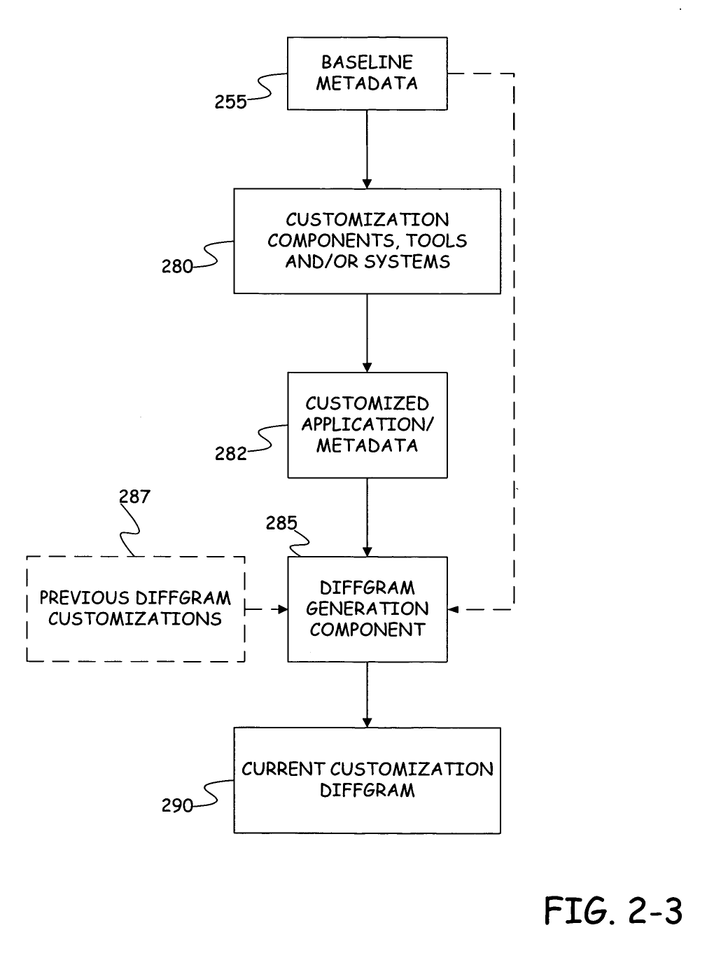

Having stored individual customizations of the original application product in the form of diffgrams, if the original company ships an updated version of the page metadata, all ISV, administrator and end user customizations can still be applied to the new version, and the user will see the new metadata changes from the original company. Further, multiple ISV's can each add a set of customizations all of which would work together to produce a composite version of the metadata. These four levels (Original Company, ISV, Administrator and End User) are only provided as examples and do not represent an exhaustive list of potential layers of customization. FIG. 2-1 is a flowchart 200 illustrating a method of retrieving or loading a metadata instance in one example using the methodology described above.

As illustrated in FIG. 2-1, a metadata instance retrieval operation is initiated at 205. To load or retrieve a metadata instance for an application, at step 210 the original metadata instance from the software developer is loaded. The original metadata instance can also represent upgraded products to which previous customizations can be applied. At steps 215, 220 and 225, respectively, 0 to n customizations from ISVs, administrators, and/or users are applied. The customizations applied in these steps are in the form of diffgrams. In some embodiments, each diffgram represents the differences between the corresponding particular metadata customization and the baseline metadata. In other embodiments, each diffgram can represent differences between the corresponding particular metadata customization and a previous particular metadata customization. In these embodiments, the metadata customizations would typically be applied in order, with earlier customizations applied before later customizations. With all customizations applied, the metadata instance is returned at step 230.

FIG. 2-2 is a block diagram which illustrates a metadata retrieval component 275, of a customized application retrieval system 240, configured to implement methodology of disclosed embodiments. As shown in FIG. 2-2, a company or software application developer 250 creates baseline metadata 255 for the application. To customize the product, ISV(s) 260 can create ISV customizations which are stored in the form of ISV customization diffgrams 262. Likewise or instead, administrator(s) 265 can create administrator customizations which are stored in the form of administrator customization diffgrams 267. Finally, in addition to or instead of these previous customizations, user(s) 270 can crate user customizations which are stored in the form of user customization diffgrams 272.

Metadata retrieval component 275 is configured to load the baseline metadata instance 255 and to obtain diffgrams (e.g., diffgrams 262, 267 and/or 272) corresponding to customizations of the baseline metadata instance for the application. In some embodiments, metadata retrieval component 275 obtains diffgrams corresponding to customizations by accessing or obtaining a diffgram store 277 (e.g., a list, database, table, etc.) which logs the various customizations that have been made. The metadata retrieval component 275 then applies the diffgrams to the baseline metadata 255 to generate a customized metadata instance 279 which defines the customized application.

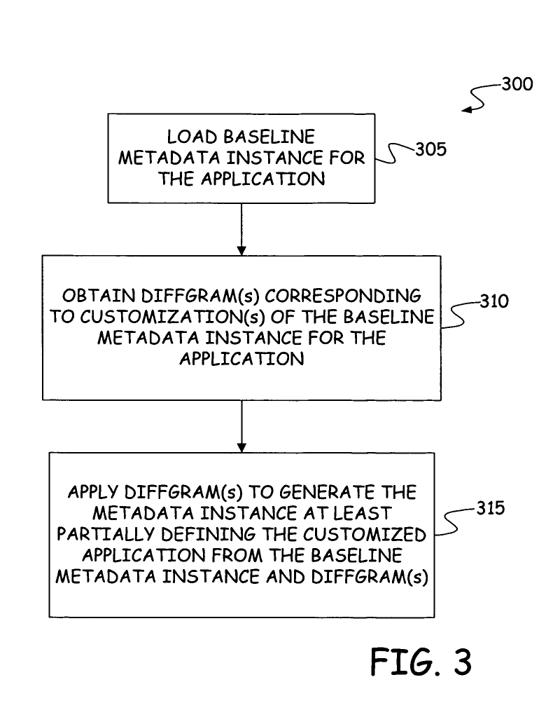

FIG. 2-3 is a block diagram which illustrates a diffgram generation component 285 in the context of an application customization process. As shown in FIG. 2-3, using baseline metadata 255, typical customization components, tools, systems and methodology (collectively shown at 280) are used to generate a customized application. The customized application can be considered to be in the form of customized application metadata 282. Then, using one or both of baseline metadata 255 and previous diffgram customizations 287 (for example customizations 262, 267 and/or 272), diffgram generating component 285 generates a current customization diffgram 290. Current customization diffgram 290 is representative of any customization such as customizations 262, 267 and/or 272.

Referring now to FIG. 3, shown is a flow diagram 300 illustrating a method embodiment of obtaining a metadata instance defining a customized application. As shown at step 305, the method embodiment includes loading a baseline metadata instance for the application. Also, as shown at step 310, the method embodiment includes obtaining at least one diffgram. As noted above, each diffgram correspond to a customization of the baseline metadata instance for the application. Then, as shown at step 315, the method includes applying the one or more diffgrams to generate the metadata instance, defining the customized application, from the baseline metadata instance and the at least one diffgram.

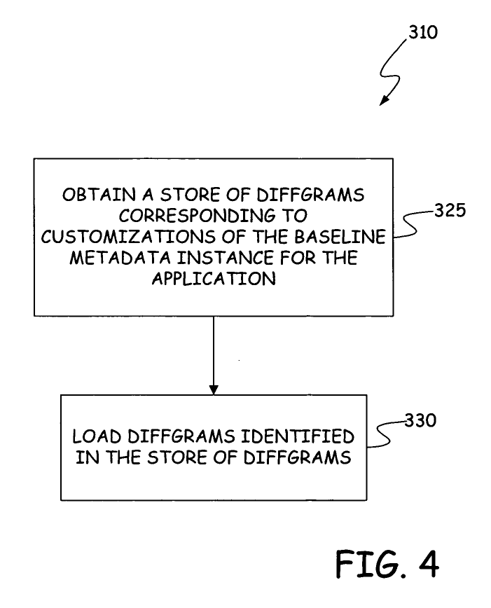

Referring now to FIG. 4, shown is a more detailed and alternate embodiment of step 310 from FIG. 3. In the embodiment shown in FIG. 4, step 310 includes the step 325 of obtaining a store (e.g., accessing store 277 shown in FIG. 2-2) of diffgrams corresponding to customizations of the baseline metadata instance for the application, and step 330 of loading diffgrams identified in the store of diffgrams.

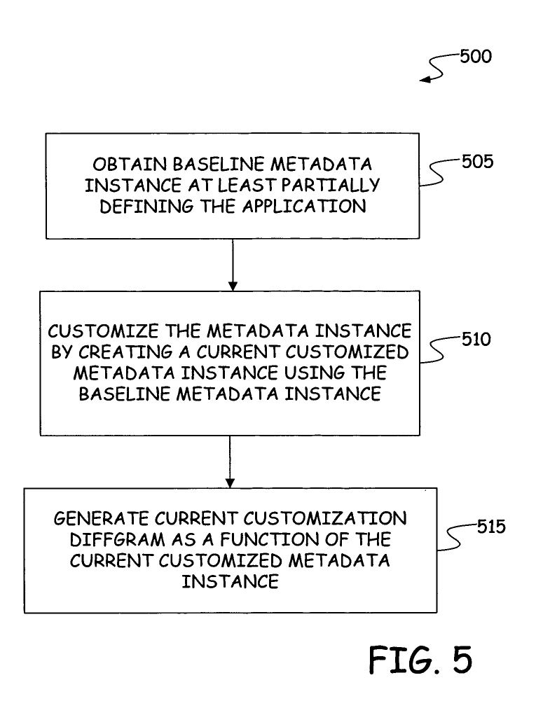

Referring now to FIG. 5, shown is a flow diagram 500 illustrating a further method of customizing application metadata to define a customized application. As shown at step 505 in FIG. 5, the method includes obtaining a baseline metadata instance (e.g., baseline metadata instance 255 shown in FIGS. 2-2 and 2-3) defining at least part of an application. Then, at step 510, the method includes customizing the application by creating a current customized metadata instance (e.g., customized metadata 282 in FIG. 2-3) using the baseline metadata instance. Then, at step 515, the method includes generating a current customization diffgram (e.g., diffgram 290 shown in FIG. 2-3) as a function of the current customized metadata instance. As noted above, the current customization diffgram can be generated such that it is indicative of differences between the current customized metadata instance and the baseline metadata instance.

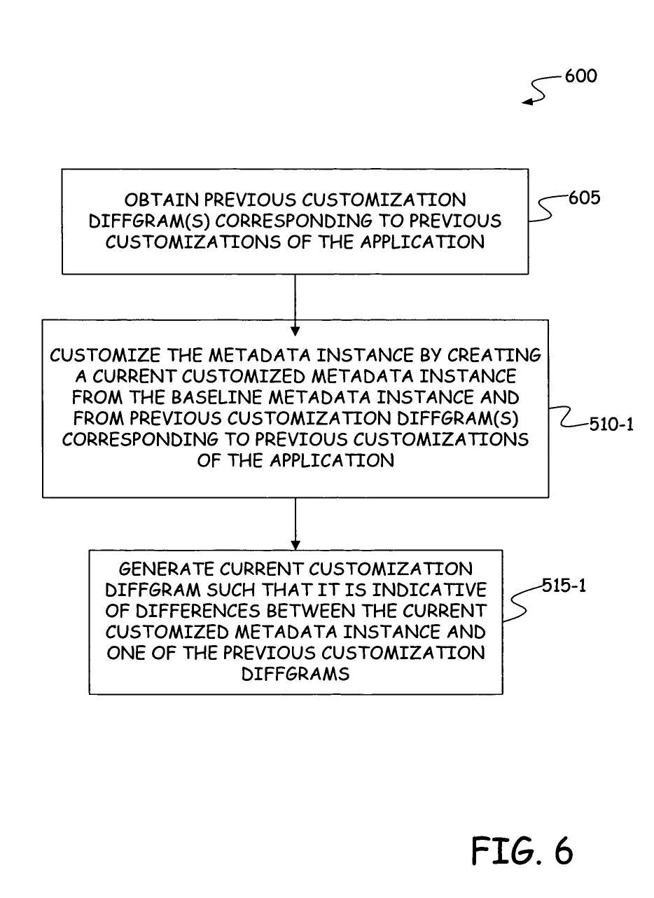

Referring now to FIG. 6, shown is a flow diagram 600 illustrating additional steps to the method of FIG. 5 which can be implemented prior to step 515 in some embodiments. As shown at step 605 in FIG. 6, prior to step 510, these embodiments can include obtaining one or more previous customization diffgrams corresponding to previous customizations of the application. In this case, an alternate embodiment of step 510, represented as step 510-1, is used. In step 510-1, customizing the metadata instance further comprises customizing the metadata instance by creating the current customized metadata instance from the baseline metadata instance and from the one or more previous customization diffgrams. In these embodiments, the step 515 of generating the current customization diffgram can be implemented as shown at 515-1 by generating the current customization diffgram such that it is indicative of differences between the current customized metadata instance and one of the previous customization diffgrams.

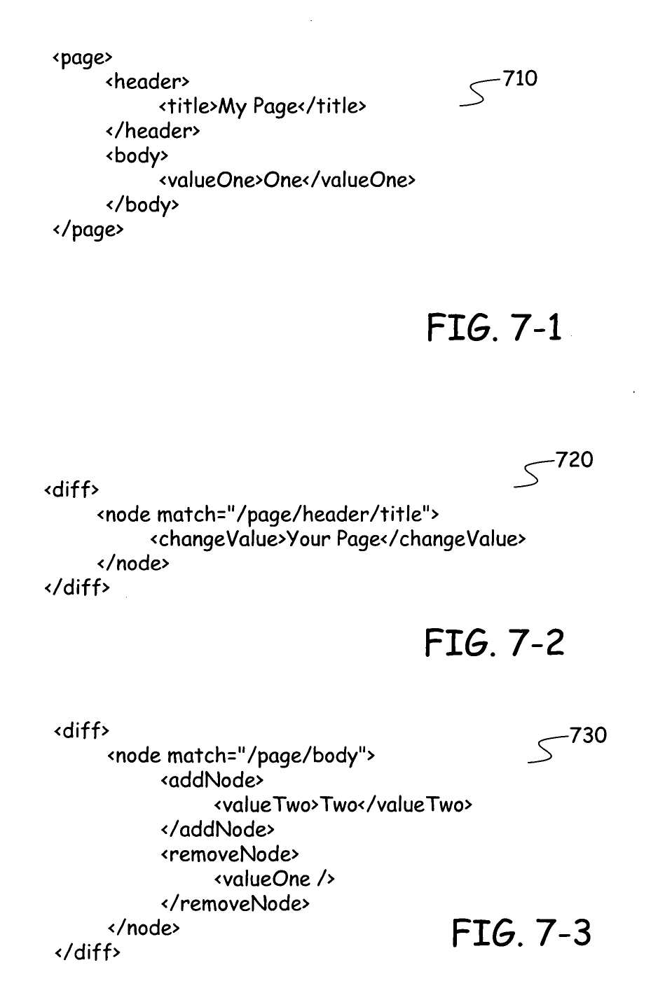

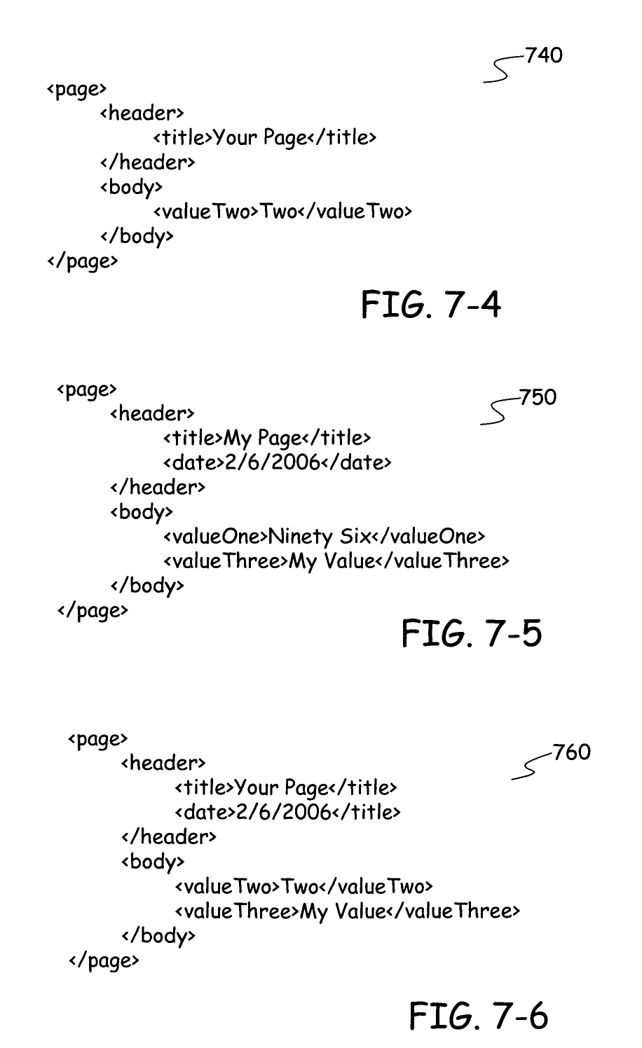

Referring now to FIGS. 7-1 through 7-6, shown is an example of metadata customization using diffgrams. This example is provided to aid in understanding some disclosed embodiments, but it must be understood that the disclosed embodiments are not limited by this example. Referring now specifically to FIG. 7-1, shown is an example of a sample default XML metadata definition 710. FIGS. 7-2 and 7-3 respectively illustrate first and second diffgrams 720 and 730 that can be applied to default metadata definition 710 for customizations. In one embodiment, when diffgrams 720 and 730 are applied, the resultant metadata instance 740 shown in FIG. 7-4 is obtained.

Referring now to FIG. 7-5, shown is the case of the default definition 710 from FIG. 7-1 having been updated to a new default metadata definition 750. Using the diffgram customization techniques, the diffgrams 720 and 730 can still be applied to new default metadata definition 750, with the resultant metadata instance 760 being shown in FIG. 7-6. Thus, updating or upgrading of the original default or baseline metadata definition does not require all previous customization work to be repeated. Using the diffgram techniques of disclosed embodiments, previous customization diffgrams can be reapplied to the updated baseline metadata definition.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of obtaining a metadata instance defining a customized application, the method comprising:
loading a baseline metadata instance for the application;
obtaining at least one diffgram, each of the at least one diffgram corresponding to a customization of the baseline metadata instance for the application; and
applying the at least one diffgram to generate the metadata instance defining the customized application from the baseline metadata instance and the at least one diffgram.

2. The computer-implemented method of claim 1, wherein obtaining the at least one diffgram further comprises:
obtaining a store of diffgrams corresponding to customizations of the baseline metadata instance for the application; and
loading diffgrams identified in the store of diffgrams.

3. The computer-implemented method of claim 1, wherein obtaining the at least one diffgram further comprises obtaining a plurality of diffgrams each corresponding to a different one of a plurality of customizations of the baseline metadata.

4. The computer-implemented method of claim 3, wherein obtaining the plurality of diffgrams further comprises obtaining at least one diffgram corresponding to a customization of the baseline metadata by an independent software vendor.

5. The computer-implemented method of claim 3, wherein obtaining the plurality of diffgrams further comprises obtaining at least one diffgram corresponding to a customization of the baseline metadata by an administrator of a computer system on which the customized application is to be run.

6. The computer-implemented method of claim 3, wherein obtaining the plurality of diffgrams further comprises obtaining at least one diffgram corresponding to a customization of the baseline metadata by a user.

7. The computer-implemented method of claim 1, wherein loading the baseline metadata instance comprises loading a baseline XML metadata instance, and wherein obtaining the at least one diffgram further comprises obtaining at least one XML diffgram.

8. A computer-implemented method of customizing application metadata to define a customized application, the method comprising:
obtaining a baseline metadata instance for an application;
customizing the baseline metadata instance by creating a current customized metadata instance using the baseline metadata instance; and
generating a current customization diffgram as a function of the current customized metadata instance.

9. The computer-implemented method of claim 8, wherein generating the current customization diffgram comprises generating the current customization diffgram such that it is indicative of differences between the current customized metadata instance and the baseline metadata instance.

10. The computer-implemented method of claim 8, and before customizing the application further comprising obtaining at least one previous customization diffgram corresponding to previous customizations of the application, wherein the step of customizing the baseline metadata instance by creating the current customized metadata instance further comprises customizing the baseline metadata instance by creating the current customized metadata instance from the baseline metadata instance and from the at least one previous customization diffgram corresponding to previous customizations of the application.

11. The computer-implemented method of claim 10, wherein generating the current customization diffgram comprises generating the current customization diffgram such that it is indicative of differences between the current customized metadata instance and one of the at least one previous customization diffgram.

12. The computer-implemented method of claim 8, wherein generating the current customization diffgram further comprises generating a current customization XML diffgram.

13. A customized application retrieval system comprising:
baseline metadata for the application;
at least one application customization diffgram, each of the at least one application customization diffgram corresponding to a customization of the application; and
a metadata retrieval component configured to load the baseline metadata for the application and the at least one application customization diffgram, the metadata retrieval component further configured to apply the at least one application customization diffgram to the baseline metadata to generate a customized metadata instance.

14. The customized application retrieval system of claim 17, and further comprising a diffgram store which stores data indicative of the at least one application customization diffgram.

15. The customized application retrieval system of claim 13, wherein the baseline metadata for the application comprises a default metadata definition for at least part of the application.

16. The customized application retrieval system of claim 15, wherein the default metadata definition for at least part of the application is an XML metadata definition.

17. The customized application retrieval system of claim 16, wherein each of the at least one application customization diffgram is an XML diffgram defining differences between the default metadata definition and an XML customization of the default metadata definition.
